(19) United States
(12) Patent Application Publication
(10) Pub. No.: US 2006/0098009 A1
(43) Pub. Date: May 11, 2006

(54) Method and apparatus for ray and range queries using wide object isolation techniques

(75) Inventor: Miguel Ramon Zuniga, Edison, NJ (US)

Correspondence Address: MIGUEL R. ZUNIGA, 16 FAYETTE STREET, EDISON, NJ, 08817, US

(73) Assignee: Miguel Ramon Zuniga, Edison, NJ (US)

(21) Appl. No.: 10/904,211

(22) Filed: Oct. 28, 2004

(51) Int. Cl. G06T 15/40

(52) U.S. Cl. 345/421

(57) ABSTRACT

A method and apparatus for automatic creation of computer data structures for performing ray and range queries; and which said method and apparatus can improve various performance metrics of the data structures, such as query speed, data structure build time, and memory footprint of data structures. The method and apparatus achieves the improvements through partitioning via the isolation of wide objects in the creation of data structures, or through partitioning via the isolation of objects that contribute to bounding box of the set of objects being portioned. Furthermore, the method and apparatus is used in the creation of the DE-tree binary search tree innovation. The experimental results of the tray tracing of the standard procedural database scenes with a ray tracer using the DE-tree suggests that innovations presented herein are in fact improvements over the state of the art.

### BACKGROUND OF INVENTION

1. Field Of Invention

This invention relates to methods and apparatus for improved information retrieval, particularly to the automatic creation of computer data structures in consideration of the isolation of wide objects, and the use of such data structures in algorithms for performing ray and range queries, and the application of such data structures and algorithms to ray tracing to generate computer images.

2. Discussion of Prior Art

An important component of computer science research is in the design of data structures and associated algorithms to perform or execute calculations in a manner is efficient or require less computer resources in terms of time, space or other measures. Certain common, general purpose, or even ubiquitous calculations are the focus of computer science research; and some of these calculations are ray, range and related queries such as metric queries. Data structures supporting ray and range queries are of wide and common usage since they support two of the most natural queries one can ask concerning a collection of physical objects: what are the nearest objects in a given direction; and what are the objects in a given range of a location. Using such queries one can directly and efficiently support or even make feasible many important calculations such as visibility determination in computer graphics, collision detection in simulation systems, range searching in relational databases, and spatial searching in geographic information systems.

This patent is largely concerned with general purpose data structures and associated algorithms but for practical reasons we also focus on their application to ray tracing in computer graphics. Computer graphics and its underlying theoretical framework of computational geometry are themselves two vast fields that are fundamental to many commercial industries including: engineering design and manufacturing, computer gaming, animated films, medical imaging, and scientific visualization. Computational geometry is the algorithmic study of geometric problems and objects. Its emergence coincided with the explosion of computer graphics, which is both a principal consumer and principal inspirer of computational geometry innovations.

Ray tracing is a computer graphics technique for the rendering or image synthesis of scenes. It is a particularly useful technique because by itself it can generate images of photorealistic quality [Appel68, Whitted80, Cook84]. It is also a central part of other more recently developed computer graphics techniques [Cook91, Shir91 Wall94]. However, its principal problem of relatively slow rendering times has for decades been the focus of much research. Survey and textbook presentation of some of this ongoing computational geometry research can be found in [Prep85, Over88, Arvo89, DeBerg97, and Havra00A]. The last reference is now a computer graphics modern classic and has an up-to-date and nearly exhaustive comparison of the algorithms and data structures used in ray tracing, including some prior art and data which will be quoted herein. As one will find in these and other references, ray tracing may be correctly and most efficiently performed by the repeated use within the ray tracing program of an algorithm or data structure nowadays called an ray shooting algorithm or RSA. These RSAs are very general purpose data structures and algorithms, some of which with slight modifications can support other common types of queries. Some of the RSAs compared in [Havran00A], include BSP trees (or binary space partition trees), kd-trees, octrees, bounding volume hierarchies, uniform grids, and adaptive grids. Most frequently they are used a software components by other programs such as a ray tracing program s, computer simulation systems, computer games, relational database engines, etc. However, they can be also compiled into hardware or placed on silicon. For example, [Lath03] has an invention for incorporating the octree in hardware.

Progress on ray query algorithms or ray shooting algorithms (RSAs) has only very recently allowed the interactive rendering of certain ray traced scenes on home computers [Wald01] and of monolithic 3D scenes [Wald04]. U.S. patents have earlier been awarded for techniques that promised some means of ray tracing at a fast speed, for example, [Wrig99] and [Sudar00]. [Wrig99] presents one method of ray tracing but said method is in some ways brute force and tailored for massive parallelization that is only available on extremely expensive computers. The invention presented in [Sudar00] can help in some situations where extremely similar images are created one after the other, such as in the rendering of certain dynamic scenes. However, it still relies on octree, BSP trees or kd-trees and what the method does is to decrease the frequency of the recreation of such search trees as their slow creation time is a problem. Of central importance to the achievements of [Wald01] and [Wald04] are the BSP tree and kd-tree RSAs, and in addition to these rendering achievements defining the state of the art, there is also theoretical considerations [Szirm02] and extensive experimentation [e.g. Sung92, Havra00A, Wald04B] identifying variants of the BSP trees and kd-trees as the best performing RSAs in terms of ray query time and other key metrics. In Havra00A and in V. Havran and J. Bittner [Havra02], there is also presented a large number of techniques that further the state of the art in BSP tree and kd-tree performance, including improved partitioning, partitioning based on ordinary surface are heuristics (OSAH), automatic termination criteria (ATC), splitting plane split clipping (SC), and memory mapping for BSP trees. [Wald04B] provides further testimony to the significance of what is presented in [Wavra00A] and [Havra02 ] to todays leading commercial renderers such as OpenRT (www.openrt.de).

It is well know that BSP trees and kd-trees have the drawbacks of high tree creation times and potentially high memory requirements [deBerg97, Sudar00]. Their efficient search times are in part obtained by the implicit ordering of information contained in the tree, and said ordering allows the search process to terminate when the first ray intersecting primitive is found. The ordering information in turn is in part possible because in the tree creation phase, when a node is split by a plane, if an object straddles the splitting plane then both the right and left child of the node will somehow be made to have a reference to that primitive. This can result in many nodes and/or references in the tree per original graphics primitive. Though binary search trees by their logarithmic nature will maintain practical search performance in terms of number of nodes visited with increased tree size, we are left with large memory usage and with increased tree build times. For example, though the state of the art techniques in [Wald04] allow the rendering of monolithic scenes (e.g. The well known “boeing 777” scene of 350 million triangles) at interactive frame rates, these large scenes require many hours of preprocessing or preparing search data structures prior to ray shooting. Therefore improving these features would be useful for the preparation of monolithic scenes, for the rendering dynamic scenes, or for any application where build time and memory usage are important.

Finally, a principal motivations for us to focus on ray tracing as an application of the inventions is the existence of widely used methods and metrics within the context of ray tracing for verifying and comparing the relative and absolute efficiency of algorithms. That is, we are not merely forwarding the state of the art of ray tracing itself, but we are using ray tracing because it provides methods to prove that the general purpose data structures and algorithms invented are themselves an improvement over the state of the art. This should also provide some support to the inventions novelty, uniqueness and importance. The principal benchmark is the standard procedural database (SPD) [Haine87] and the most exhaustive and common metrics are those proposed in [Havra00A] and [Havra00B]. Later sections will present results on these the benchmark from testing the preferred embodiment.

### OBJECTS AND ADVANTAGES

The objects and advantages of the present invention will be listed below in two sections: as general objects and advantages; and the objects and advantages as measured in the process of ray tracing with the preferred embodiment RSA.

### GENERAL OBJECTS AND ADVANTAGES

The objects and advantages of the algorithms and data structures described in my patent will depend on how they are used within and in conjunction with other algorithms. For example, my tree creation algorithms may be used in the building of BSP trees. The general advantages of my algorithms are:

Improved search performance of ray query, range and related query algorithms as determined by measures of performance such as query time or number of nodes visited. In particular:

a) Improved robustness of the search performance of ray, range and related query algorithms to variations of object sizes and distributions of scenes to represent or render.

b) Overall reduced computer memory consumption of the search data structure.

c) The ability to render or otherwise represent larger scenes or greater number of objects with search data structure.

d) A reduction in the time used by the computer to create the search data structure.

e) Improved robustness, to variations of object sizes and distributions, of the algorithms used to create ray query data structures and range query data structures.

f) As a direct consequence of e) the ability to use the data structure as a dynamic data structure for larger scenes.

g) As a consequence of e) or of a), an increase in the scene design turnaround time or an increase in the productivity of artists that create scenes for graphics.

h) As a consequence of c), e) or a), the ability to represent, query or render larger scenes on cheaper computers.

i) Decreased need to perform compute-intensive tests such as ray-primitive intersection tests.

### PREFERRED EMBODIMENT

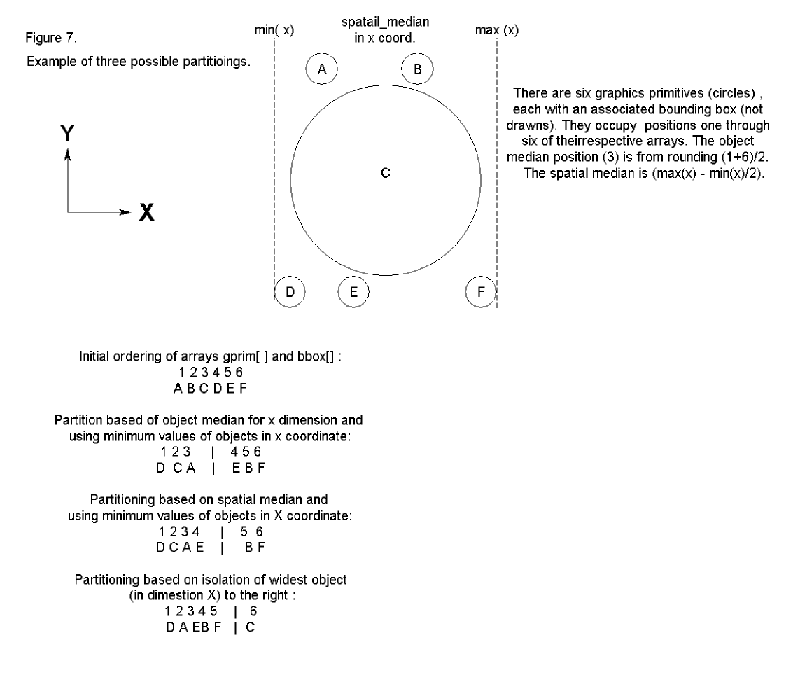

A preferred embodiment of the invention is illustrated with the figures depicting the main components of a search tree data structures and associated algorithms: FIG. 1 illustrating pseudocode defining the tree nodes, records, or units of computer memory used in creating the search tree; FIG. 2 illustrating pseudocode for the search tree creation algorithm; and FIG. 3 which illustrates the search algorithm of the tree. We call this embodiment the DE-tree data structure and associated creation and search algorithms, or just the DE-tree. Below each figure there are explanatory paragraphs. Also, FIG. 7 in the drawings section provides some concrete examples useful in understanding the pseudocode of FIG. 2.

[image]

[image]

FIG. 1 illustrates the member variables or computer memory fields comprising the each of records we will call the dual extent nodes or DENodes. These fields are:

(1) splitDim which is the nodes partitioning dimension (this cab be maintained with two bits)

(2) Four fields labeled min, max, lmax and rmin. For the splitDim coordinate of the DENode, min and max specify the range or the spatial extent of all objects associated with the node; min and lmax specify the range or the spatial extent of all objects associated with the nodes' left child; and rmin and max specify the range or the spatial extent of all objects associated with the nodes' right child.

(3) isLeaf (a boolean) indicating if the node is a leaf or an internal tree

(4) isNull (a boolean) to indicate if the node is null.

(5) Obj which is a reference or pointer to a graphics primitive.

(6) lnode and rnode which are pointers or references to the left child and right child, respectively, of the node

As is standard with many kinds of binary search trees, the DENodes of the preferred embodiment are either:

(1) internal tree nodes that have references to other tree nodes and do not have reference to a graphics primitive.

(2) leaf nodes that have references to graphics primitive but not to other tree nodes.

Because of this above, It is convenient for the fields lchild and obj to share space, as through the union capability in some programming languages such as C++:
union {DENode*lchild; GraphicsPrimitive*obj }
Furthermore, many programming languages will allow the allocation of two (or more) contiguous DENodes, and so the value or location of rchild will be know once it is know for lchild. That is, the nine fields of structure DENode would be represented with less fields in some programming languages.

[image]

[image]

Algorithm M3 of FIG. 2 creates a tree of DENodes. The client or user of the DE-tree will have a scene with a collection of graphics primitives which FIG. 2 refers to as gprim[ ]. As is commonly used in much of computer graphics, each graphics primitive will have an associated axis aligned bounding box (AABB), and so for gprim[ ] there is an associated collection of such boxes referred to in FIG. 2 as bbox[ ]. Examples of graphics primitives are three dimensional spheres, triangles, and polygons. Also as an example, a sphere of unit radius centered at the origin has an AABB that is a cube, also centered at the origin and having a width of two in each dimension. gprim[ ] and bbox[ ] are assumed to be arrays as used in modern computer programming languages. For each of the arrays, left and right are the first and last numeric indexes into the first and last elements of each these two arrays. gprim[ ] and bbox[ ] are passed into algorithm M3. Each iteration of algorithm M3 repeatedly partitions gprim [left, . . . , right] and bbox [left, . . . , right], each into two sets that are to used in later executions of M3 through recursions:
gprim[left, . . . , pos] and gprim[pos+1, . . . , right]
bbox [left, . . . , pos] and bbox [pos+1, . . . , right]
where pos is a variable declared in each iteration of algorithm M3 and is between variable left and variable right in value. In a rough sense, the arrays are partitioned implicitly into the sets left and right of position pos or the objects at position pos. More specifically, both steps 2) and 3) of algorithm M3 partition by comparing numeric values associated with the graphics primitives and AABBs. Per graphics primitive and its associated AABB, assume said numeric value to be the minimum value of the extent of the AABB in the dimension d of the current node nd. Partitioning is essentially done by determining pos, and moving each element of gprim[ ] and bbox[ ] to the left or to the right of pos within gprim[ ] or bbox[ ]. Detailed description of partitioning by the object median similar to what is done in step 2, and of partitioning by the spatial median as is done step 3 can be found in the standard reference of [Havra00A]. Replacing the discarding object median partition and replacing it with the spatial media partition under some circumstances as it is done is step 3 is believed to be novel to this invention.

Also in FIG. 2, the argument node is a pointer to a DENode that is to be used, and the argument d is a pointer to the next coordinate to be used.

FIG. 2 makes reference to variables called nodes extent measures. With the function abs( ) being the absolute value function, we say these are the extent measures:

(1) wt=abs(node->max−node->min);

(2) wl=abs(node->lmax−node->min);

(3) wr=abs(node->max−node->rmin);

These are the extents of the node, the left child, and the right child, respectively. They will be used in determining how a partitioning is to be made.

Algorithm M3 has the very common feature of creating, in a top-down fashion, a binary search tree that partitions each tree node into two child nodes using alternating splitting dimensions, and each child node is left with a subset of the parent nodes objects or graphics primitives and AABBs. The very first time the algorithm is called it is the root node that is partitioned. Algorithm M3 also has the novel and extremely important feature that it uses more than one partitioning scheme, where one of the said schemes is that performed in step 4 and said scheme we will call partitioning by isolation. For algorithm M3, Partitioning a node first occurs by selecting a splitting plane based on object median, or step 2 in FIG. 2. For the same node, this partitioning may be discarded and replaced with a partitioning based on the spatial medians or step 3 of FIG. 2. For the same node, the second partitioning may itself be discarded and replace with partitioning based on isolation, or step 4 of FIG. 2. We call it partitioning by isolation because in said partitioning the widest objects (the one or single graphics primitive and its associated AABB) are the only ones that will be assigned to the child node that it is assigned to. In FIG. 2, partitioning by isolation is the final partitioning scheme for a given node and its collection of graphic primitives and AABBs. Also, In this embodiment, partitioning by isolation occurs when it is decided that, for the current node, the earlier two partitioning schemes resulted in partitions that were not good enough.

Through a typical execution of M3, some nodes will only use the first partitioning scheme; some others will use the first scheme, reject it and repartition with the second scheme and accept that second partitioning; and yet some will apply these both and reject them to finally settle on the partitioning provided by the isolation scheme.

M3 uses certain parameters which may be adjusted for improved performance but which remain constant for all test results presented here. Their constant settings are:

wfac=0.98

meanRedo=1.33

minForlsolation=8.

[image]

[image]

[image]

FIG. 3 is detailed pseudocode of the recursive ray query search algorithm for the DE-tree. The client calling it specifies the root node, the ray, and mint and maxt. Argument mint is and estimate of the nearest possible distance to the ray origin from any primitive and it is usually set to zero. Argument maxt is an estimate the furthest distance form the ray origin. The search algorithm traverses the binary tree starting from the rood node. For any node that it visits, it determines if the ray can intersect it, based on the ray definition and on the nodes extent as specified by the nodes min and max parameter values. Said determination is performed by using one of three possible components of either a ray-box intersection test or a ray-box rejection test. The component is based on the coordinate or the spliDim value of the current node. If the ray cannot intersect the segment then the algorithm returns. Otherwise of of two things will occur:

(1) if the current node is a leaf node then it will perform leaf node processing such as executing ray-graphics primitive intersection tests for the leaf node. The intersection test will determine the point of intersection, if any, and store it. The algorithm returns once these tests are done.

(2) Based on calculations with the ray and the extents of the two child nodes, it may recursively call itself once per child node.

Preferred embodiment operation:

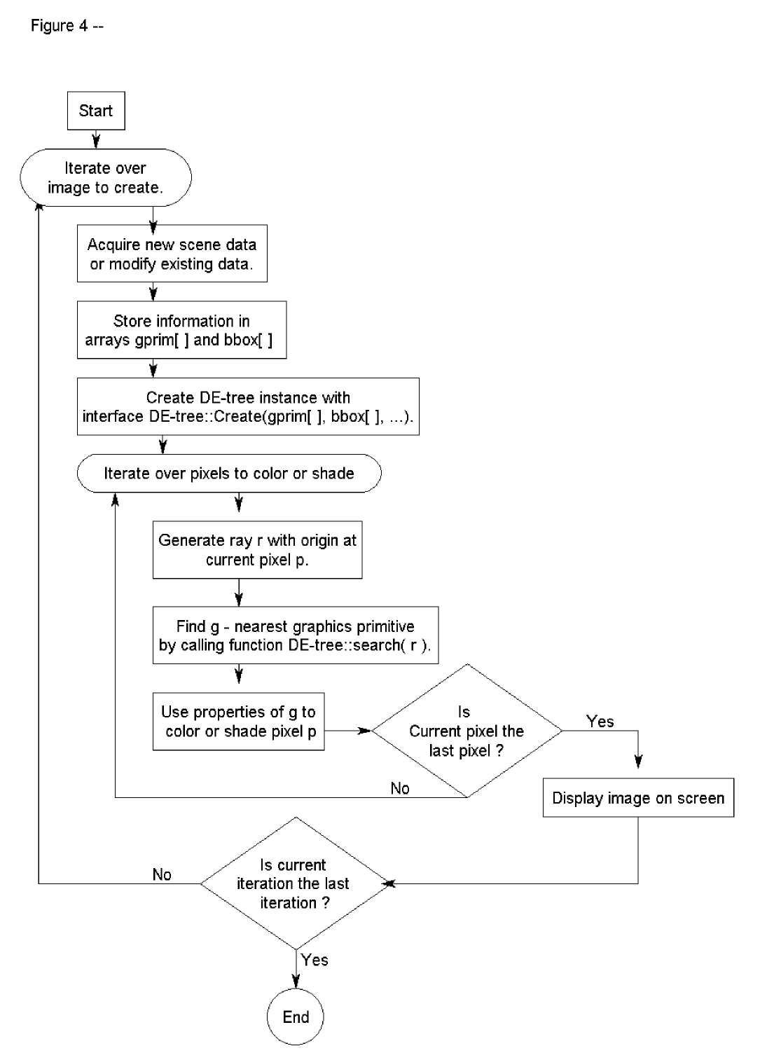

Also, FIG. 4 illustrates the use of the DE-tree within a ray tracing program. The ray tracing program FORT using the DE-tree is included as an attachment to this patent, including an executable and full source code.

The key idea is that in the process of rendering, an application repeatedly uses the query function (called DETree::search (ray)). Also, at least once prior to calling function DETree::Search (ray), the application has called function DETree::Create (gprim [ ], bbox [ ], numberObjects) in order to create the binary tree. The binary tree would have to be re-created when the scene is changed. The input of an entire new scene or the changing of the position of one graphics is a change in scene that might warrant the re-creation of the binary tree.

Perhaps the most important observation associated with the search efficiency of the M3 created DE-tree is that objects that have relatively fat or wide AABBs in one dimension (1 D widely boxed objects) can occur at a high frequency, and that isolation of such objects improves the search efficiency. With this observation we associate a design principle to isolate problem causing wide AABB objects during the RSA construction. The problem can be an expected problem in either in search performance or space used. Step 4 in algorithm M3 is an example of an isolation technique or process following the principle. Experimentation has shown that all SPD scenes except lattice have non-zero occurrence of partitioning by isolation of 1 D-wide objects that are at least 90% as wide as the 1 D extent of the node being partitioned, and this includes some scenes of uniformly sized objects. For example, although all tetra scene triangles are of the same size, the triangles AABBs will not be uniformly sized in any one given dimension given a coordinate axis, and consequently nodes in a tree containing subsets of AABBs will occasionally have one or more of its AABBs that are relatively wide in the current working dimension. Not isolating the extremely wide boxed objects at a node to be partitioned tends to make the child nodes have a large overlap and therefore precludes the search algorithm from determining which is the best child node to visit first, and also tends to force visitations of both child nodes. Do to the very same object, the problem may be repeated at sub branches or child nodes. Performing the objects' isolation, on the other hand, tends to remove these problems. Finally, since algorithm M3 tends to isolate the widest objects sooner, the resulting tree has the feature that the widest objects have relatively shorter distances to the root node, which in turn seems to result in some additional search effectiveness such as the tendency to sooner evaluate the ray-object intersection tests of the widest objects

Measured Objects and Advantages the preferred embodiment.

Tables 1 and 2 include performance data of rendering the standard procedural database (SPD) scenes [Haine87] with the preferred embodiment used as the RSA of the FORT ray tracing program. Data for other RSAs in these tables are derived from [Havra00A] and [Havra02]; these other RSAs are used within the GOLEM rendering system. The OSAH+AT kd-tree information is from line 45 of the tables in Appendix E of [Havra00A]; the OSAH+AT+SC kd-tree information is from [Havra02] and they were selected for comparison as they appear to be the best performing RSAs . The BES RSA is the best efficiency scheme (BES) program winner (winner based on ray tracing time) within GOLEM prior to the innovations that lead to the OSAH+AT kd-tree development. The RSAs that competed in the BES program included BSP trees, kd-trees, octrees, bounding volume hierarchies, uniform grids, and adaptive grids, and results for all these RSA are included in Havran00A and on the GOLEM website. Table 1 includes averages for the key performance parameters of the ten SPD scenes of Group 4 and of Group 5 (the SPD scenes of roughly 10⁴ and 10⁵ primitives). Data for the uniform grid (UG) is included in this table simply because of its popularity and its small RSA build time for small scenarios. Table 2 includes data for individual scenes within G⁵. For the sake of recording computational complexity, we have provided an extra row in table for a larger scenario (rings40) which appears as the “toughest” scenario for the DE-tree based FORT. Further data and pictures can be obtained from the GOLEM homepage.

For the FORT runs that produced the data below, the ray queries are performed one query at a time in the classic ray tracing sense and the details of the rendering are strictly done according to the rules itemized in the SPD Readme.txt file (e.g. 513×513 primary rays, plus an additional four levels of reflection). The goal is not to create the fastest renderer possible but to test and measure the efficiency of RSAs. FORT does not use shadow buffers or light buffer algorithms, primitive caching, nor does it take advantage of spatial or temporal coherence, etc. FORT uses explicit box-ray intersection tests only for some parts of the gears scenario, i.e. ray-primitive intersection tests are not generally preceded by ray-bounding-box tests. In the tested version, the DE-trees binary search tree nodes are 24 bytes in size; at most 2*Np nodes (where Np is the number of scene graphics primitives) are used in any scenario; the tree maintains exactly one reference for each of the Np graphics primitives (a leaf node has a pointer to the graphics primitive and does not use an auxiliary data structure like a linked list) . For this DE-tree, the number of internal nodes (Ng) is Np-1, the number of leaf nodes (Ne) is Np, and there no null nodes.

Test hardware:

DE-tree and FORT ray tracing timings collected on a Gateway SOLO 9300 laptop with a Mobile Pentium III at 700 MHz, 100 Mhz FSB, 256 Meg ram running SUSE Linux 8.2 kernel 2.40, gcc 3.3 at compiler options “-O2 -g” and collecting all ray tracing statistics.

Data for the GOLEM BES results are from a Pentium II 350 MHz, 100 Mhz FSB. Data for the OSAH+AT kd-tree and OSAH+AT+SC kd-tree results are from a Pentium II 466 Mhz. The spec corporation (www.specbench.org) maintains online performance metrics for similar computers.

Symbols for tables 1 and 2.
Tb—the time (in seconds) to build the RSA.
Tr—the time (in seconds) to perform all ray tracing calculations once the RSA is created.
Nts—the average number of nodes accessed per ray.
Ner—the total number of references to objects in elementary nodes of the RSA DS.
Ng—the number of generic nodes in the RSA DS (usually the number of interior nodes for tree data structures)
Ne—the maximum number of elementary nodes in the RSA DS (usually the number of leaf nodes for tree data structures).
Np—the umber of graphics primitives in the SPD scene.
Nr—the total number of rays used.
Rsi—the ratio of the number of rays intersecting objects to the number of all rays.

(Rsi<1.0)
Nit—the average number of ray-object intersection tests per ray.
Ritm—the ratio of ray-object intersection tests performed to the minimum number of intersection tests (Ritm>1.0 and also Nit=Ritm*Rsi).
UG—uniform grid
AG—adaptive grid.

BSP/kd—The BSP tree or kd-tree using AHTC (see GOLEM webpage or PhD thesis of V. Havran).

TABLE 1
Performace Averages fro SPD Scenes G4 and G5

| | SPD | | | | | | | |
|---|---|---|---|---|---|---|---|---|
| RSA | Group | Np | Ng + Ne | Ner | Ritm | Nts | Tb | Tr |
| DE-tree | G⁴ | 7636 | 15272 | 7636 | 5.94 | 29.2 | 0.04 | 10.9 |
| Kd-tree | G⁴ | 7636 | 16634 | 19515 | 15.1 | 24.47 | 2.02 | 26.7 |
| ATC | | | | | | | | |
| Kd-tree | G⁴ | 7636 | 33811 | 25879 | 12.3 | 26.7 | 1.2 | 15.1 |
| OSAH + TA | | | | | | | | |
| Kd-tree | G⁴ | 7636 | 34925 | 22824 | 9.8 | 26.8 | 2.6 | 14.8 |
| OSAH + TA + SC | | | | | | | | |
| UG | G⁴ | 7636 | 38369 | 36013 | 283.9 | 13.97 | 0.39 | 100.4 |
| DE-tree | G⁵ | 98881 | 197762 | 98881 | 6.05 | 35.8 | 0.57 | 13.4 |
| Kd-tree | G⁵ | 98881 | 46227 | 147514 | 41.69 | 26.99 | 22.7 | 40.4 |
| ATC | | | | | | | | |
| Kd-tree | G⁵ | 98881 | 501817 | 367546 | 12.35 | 35.22 | 22.75 | 19.1 |
| OSAH + TA | | | | | | | | |
| Kd-tree | G⁵ | 98881 | 525099 | 328496 | 9.6 | 35.1 | 66.34 | 18.5 |
| OSAH + TA + SC | | | | | | | | |
| UG | G⁵ | 98881 | 471705 | 385702 | 754.9 | 28.8 | 5.67 | 282.3 |

TABLE 2
Performace Comparison for Individual Scenes within SPD G5

| | SPD | | | | | | | | |
|---|---|---|---|---|---|---|---|---|---|
| RSA | scene | Np | Nr | Ng + Ne | Ner | Ritm | Nts | Tb | Tr |
| DE-tree | balls5 | 66430 | 1431961 | 132862 | 66430 | 3.46 | 32 | 0.39 | 13 |
| BES | balls5 | 66430 | | 14261 | 84927 | 46.33 | 27.48 | 16.77 | 42 |
| (BSP/kd) | | | | | | | | | |
| Kd-tree | balls5 | 66430 | | 160187 | 173040 | 13.5 | 35.17 | 14.8 | 18.2 |
| OSAH + TA | | | | | | | | | |
| DE-tree | gears9 | 106435 | 1809160 | 212870 | 106435 | 3.88 | 27 | 0.66 | 24.97 |
| BES | gears9 | 106435 | | 43629 | 163635 | 9.85 | 19.53 | 22.97 | 40.59 |
| (BSP/kd) | | | | | | | | | |
| Kd-tree | gears9 | 106435 | | 784291 | 757083 | 7.56 | 26.16 | 33.56 | 30.69 |
| OSAH + TA | | | | | | | | | |
| DE-tree | jacks5 | 42129 | 489754 | 84258 | 42129 | 8.49 | 45 | 0.21 | 6.12 |
| BES | jacks5 | 42129 | | 72297 | 132833 | 33.52 | 38.63 | 12.47 | 31.82 |
| (BSP/kd) | | | | | | | | | |
| Kd-tree | jacks5 | 42129 | | 386409 | 288851 | 20.08 | 53.98 | 12.55 | 20.78 |
| OSAH + TA | | | | | | | | | |
| DE-tree | lattice29 | 105300 | 1626700 | 210600 | 105300 | 4.05 | 58 | 0.5 | 26.59 |
| BES | lattice29 | 105300 | | 531441 | 749107 | 14.09 | 9.23 | 8.54 | 46.39 |
| (UG) | | | | | | | | | |
| Kd-tree | lattice29 | 105300 | | 1442715 | 802648 | 5 | 54.68 | 29.3 | 30.09 |
| OSAH + TA | | | | | | | | | |
| DE-tree | mount8 | 131076 | 713461 | 262152 | 131076 | 5.01 | 24 | 0.71 | 5.48 |
| BES | mount8 | 131076 | | 26643 | 153865 | 18.6 | 18.9 | 25.82 | 25.14 |
| (BSP/kd) | | | | | | | | | |
| Kd-tree | mount8 | 131076 | | 399809 | 182738 | 6.11 | 20.84 | 23.81 | 12 |
| OSAH + TA | | | | | | | | | |
| DE-tree | rings17 | 107101 | 1827216 | 214202 | 107101 | 9.96 | 73 | 0.68 | 38.35 |
| BES | rings17 | 107101 | | 54311 | 201209 | 39.12 | 40.25 | 23.55 | 106.61 |
| (BSP/kd) | | | | | | | | | |
| Kd-tree | rings17 | 107101 | | 608701 | 614753 | 17.94 | 54.63 | 27.46 | 50.63 |
| OSAH + TA | | | | | | | | | |
| DE-tree | rings40 | 1328401 | 1880868 | 2656802 | 1328401 | 10.48 | 90 | 11.56 | 47.96 |
| DE-tree | sombrero4 | 130050 | 374071 | 260100 | 130050 | 5.85 | 39 | 0.72 | 4.09 |
| BES | sombrero4 | 130050 | | 36659 | 135207 | 41.7 | 19.17 | 27.63 | 6.9 |
| (BSP/kd) | | | | | | | | | |
| Kd-tree | sombrero4 | 130050 | | 464257 | 171667 | 6.85 | 20.06 | 24.14 | 3 |
| OSAH + TA | | | | | | | | | |
| DE-tree | teapot40 | 103680 | 893340 | 207360 | 103680 | 6.63 | 32 | 0.59 | 8.32 |
| BES | teapot40 | 103680 | | 37186 | 181085 | 57.4 | 30.48 | 21.77 | 23.85 |
| (BSP/kd) | | | | | | | | | |
| Kd-tree | teapot40 | 103680 | | 525445 | 435017 | 12.77 | 38.29 | 22.37 | 10.76 |
| OSAH + TA | | | | | | | | | |
| DE-tree | tetra8 | 65536 | 303580 | 131072 | 65536 | 9.51 | 16 | 0.26 | 1.57 |
| BES | tetra8 | 65536 | | 38195 | 65536 | 86.38 | 20.17 | 10.61 | 3.57 |
| (BSP/kd) | | | | | | | | | |
| Kd-tree | tetra8 | 65536 | | 48264 | 65536 | 10.12 | 22 | 8.95 | 1.95 |
| OSAH + TA | | | | | | | | | |
| DE-tree | tree15 | 131071 | 1370586 | 262142 | 131071 | 3.66 | 12 | 0.93 | 5.26 |
| BES | tree15 | 131071 | | 393011 | 182880 | 79.01 | 30.31 | 370.43 | 43.38 |
| (AG) | | | | | | | | | |
| Kd-tree | tree15 | 131071 | | 145845 | 184136 | 23.56 | 20.44 | 30.54 | 12.51 |
| OSAH + TA | | | | | | | | | |

The DE-tree created with algorithm M3 has all the general objects and advantages presented in an earlier section. Additionally, as determined from the data presented in the table above it has these advantages:

a) Its build time or RSA creation time can be orders of magnitude faster than competing RSAs. On the SPD G4 and G5, it is at least several times faster to build than any RSA tested with the GOLEM system.

b) Its RSA creation time is proportional to Np*log (Np) and is relatively independent of the scenario.

c) Its search algorithm observed run time is proportional to Nr*log (Np). The search performance is scenario dependent though robust, with the average number of nodes visited per ray ranging from about log(Np) (tree scenarios) to about 4.5*log(Np) (rings scenario).

d) The average number of ray-primitive intersection tests performed per ray using the DE-tree is almost always less than four and can be less than one for some scenarios.

e) Its Ritm metric is more then a third smaller then best know competitor for this metric (the OSAH+TA+SC kd-tree). The improvement is more than a factor of two over all other competitors. Similar statements should be true concerning the number of ray-primitive intersection tests.

f) Even in cases where the scene topology is ideal for uniform grids, the number of ray-primitive intersection tests is much smaller for the DE-tree than the uniform grid. For example, for lattice29 scenario the DE-tree requires 3.5 fewer ray-primitive intersection tests.

g) Its search performance metrics Tr, or ray tracing time, is very similar to the prior best RSAs in this metric.

h) The total number of nodes and references to objects (Ne+Ng+Ner) is not only fixed given Np for the M3 created DE-tree, but on average it is several times less than any RSA that also performs well on the search.

As determined from inspection of the design of the DE-tree and algorithm M3, we also state these advantages:

a) An upper limit of only 2*Np DENodes for M3 constructed DENodes, even without a termination criteria.

b) Only one reference in the search tree per graphics primitive.

c) The search algorithm does not need to visit both child nodes before making a decision as to which to visit first.

d) DE-tree nodes may be constructed so that more than one node fits in a cache line.

e) As a consequence of the four features above, in general this embodiment has the feature of low memory usage along the promotion of reduced cache misses.

### ADDITIONAL EMBODIMENTS

Those skilled in the art of computer algorithm design will be able to use the innovations presented with the preferred embodiment to create alternative embodiments. There are many possibilities with regard to how partitioning is done in conjunction with isolation of wide objects, with the use of wide object isolation with other search data structures besides the DE-tree, with the structure of the DENodes, and with other aspects. Here we will list only a small number of the major ways that the innovations presented in the preferred embodiment may be used to design alternative embodiments of data structures and algorithms for performing ray, range and other related queries, including data structures that are not normally used in computer graphics.

One way to create additional embodiments is though the use of alternate partitioning strategies used in conjunction with isolation. A node partitioned by algorithm M3 will in the end be partitioned based on the spatial median, the object median, or through isolating the widest object. Other partitioning schemes can be used in conjunction with isolating the widest object. For example, simply be removing step 2 from algorithm M3 results in an algorithm where partitioning is performed by the spatial mean or by isolation when necessary. There are many know partitioning schemes and many of these can be used in conjunction with the isolation innovation. Some of these schemes are:

a) Partitioning by the object median.

b) Partition based on a function of the positions of the spatial and object median. The arithmetic average is an example of such a function.

c) Partitioning based on surface are heuristics. Surface are heuristics are discussed by Goldsmith and Salmon [Gold87], Macdonald and Booth [Mac90], among others.

Another way to create additional embodiments is thought he use of other heuristics to decide when or on which nodes to use isolation. Algorithm M3 makes a decision to isolate based on the quality of the prior partitioning. For example, Step 4 of algorithm M3 will decide to isolate if the prior partition has resulted in one of the child nodes having extents that are two wide. It has been shown that is possible to create an effective search tree without such measures of node partition quality. FIG. 5 is pseudocode for such an algorithm that has been tested.

[image]

[image]

Algorithm M3B illustrated in FIG. 5 decides whether or not isolate the widest object based on the extent of the widest object in comparison to the extent of the node. Also, unlike algorithm M3, algorithm M3B makes the decision to isolate the widest object of a given node prior to executing any other partitioning strategy for a node.

Additional embodiments can also be created thought the use of other search data structures can use the wide object isolation innovation to enhance their performance. The DE-Trees is not the only data structure that can use the isolation of wide object innovation to enhance performance. With some modifications common data structures such as kd-trees, BSP-trees, bounding volume hierarchies, octtrees, metric trees, m-way trees and trees with branching factors higher then two, sphere trees, AABB-trees, OBB-trees, and others can be adapted. The most straight forward method that can be applied to any of these alternate data structures is simply this:when a wide object is detected and it is desired to isolate it, the object is removed and placed into another instance of some search data structure. However, techniques can be developed so that instead the wide object is isolated to some location within the data structure, as it occurs with the DE-tree where the wide object is isolated to a leaf node of the DE-tree. It is expected that the computer graphics community will attempt to apply the wide object isolation principle to al least some of these alternative data structures.

Additional embodiments can also be created by having leaf nodes of data structures like the DE-tree contain a plurality of objects. Search data structures may be more efficient by some measures by allowing the tree's terminal node to contain more than one object or graphics primitive. During tree construction, in the process of partitioning can be terminated if the nodes properties and objects reaches some criteria other then the number of remaining objects be equal to one or zero. When such a termination occurs, the node is made a leaf node with more than one objects associated with it.

Additional embodiments can also be created by having DENodes be non-binary. For example, DENodes may be made tertiary by adding a third or middle child as an addition to the usual left and right child. Tertiary nodes have been proven useful in the context of ray tracing. They may be used for the placement of isolated objects and for the support of additional partitioning schemes.

Additional embodiments can also be created by having DENodes contain additional variables that do not make it a tertiary node or M-way node as the variables are not pointers or references to other DENodes. For example, a DENode may be designed to have a pointer or reference to a graphics primitive. Said pointer or reference is usually empty except when a wide object has been isolated for that node.

Additional embodiments can also be created by creating the DE-tree bottom up fashion. Algorithm M3 creates the tree in what is commonly called top down fashion, but for many binary search trees there exist bottom up creation algorithms as well. They key difference for the DE-tree is that as a result of the isolation innovations, when a new node is inserted into the tree, the balancing criteria will need to account for the possibility of applying isolation to objects associated with every affected node. the search data structures.

Additional embodiments can also be created by creating sections of the DE-tree as needed by the search algorithm. Almost any search of a binary tree, even a plurality of searches used in the process of rendering a complete image, will only visit a subset of all the nodes of the tree. Therefore it is of interest to avoid the creation of DENodes sections of the DE-tree that will not be used. [Hook95] contains details on the as-needed creation of another binary search tree.

Additional embodiments can also be created by creating search data structures without the use of AABBs, or search data structures that do not use AABBs. In fact, the extent information of a graphics primitive can be obtained from other means such as a mathematical function of the primitive, and said mathematical function can be invoked whenever the computer algorithms require the information. Because of efficiency concerns, some kind of bounding objects are usually used by most geometric search data structures. Besides the data structures already mentioned by common name in this patent, there are other widely used data structures within the graphics, simulation, and engineering communities that do not use AABBs but use some other kind of bounding object. Some of the bounding object types include oriented bounding boxes and spheres, and some of the data structures incilude OOB-tree (see [Gott96]), the sphere-tree (see [Palm95]), and [Hubb95]. The OOB-tree, the sphere-tree and some related data structures are frequently used in range queries and collision detection. These data structures can be used in the techniques presented in this patent for more efficient searching though the isolation of wide extent objects.

The DE-tree presented in the preferred embodiment can be used for range searching. The DENodes and the creation algorithm M3 do not require extensive modification. Instead, the search algorithm is modified as in FIG. 6.

[image]

[image]

The search algorithm of FIG. 6 starts with the client providing a root node, a query box, and a results list. The question the search algorithm answers is “what are all the objects that can intersect the space defined by the query box qbox”. The algorithm works by selectively visiting those nodes that can possibly intersect qbox. When a node is visited it is rejected if qbox is completely to the left or completely to the right of the nodes extent. If a leaf node is reached, it is saved to the results list in which stores the answer to the client. The client will likely take the answer and perform some post-processing. Finally, the current nodes left child is recursively visited if it cannot be established that the query box is completely to the right of the left child; and similarly the right child is visited if it cannot be established that the query box is completely to the left of the right child. Finally, it is worth repeating that the box or range search algorithm uses the exact binary tree structure that the ray query search algorithm uses.

Additional embodiments can also be created by isolating a small group of objects that together inhibit search performance. The multi-dimensional range or box query algorithms of the previous paragraphs decide to visit a node of a binary search tree by determining whether or not the bounding box associated with the said node intersects with the query box. In such cases, the search data structure can be made more efficient if the average sizes of the nodes bounding boxes can be decreased. For some scenarios this can be accomplished through isolation of the set of objects or bounding box that together comprise a nodes bounding box. A nodes AABB is determined by one to eight other objects or bounding boxes whose extremes contribute to the nodes bounding box. Call these one to eight objects the outer objects and their associated bounding boxes the outer bounding boxes. Call the nodes inner bounding box the bounding box of the set of objects of the node not including those objects that contributed to the outer bounding box. If the node had a large number of elements, and if the inner bounding box is much smaller in volume than the original or outer bounding box, then it could be useful to partition the node by isolating some or all of the outer objects and bounding boxes from the other objects or bounding boxes of the node. This is in analogy to isolation of the widest object for ray queries presented in the preferred embodiment.

Operation—FIG. 4 and example usage of the DE-tree.

FIG. 4 illustrates the manner which a computer program may use the DE-tree in order to generate or create images through a version of ray tracing. A key observation is that the function DETree::Search (Ray r) is repeatedly called. If there are millions of pixels per image to create and display, then said function would be called millions of times per image. In more sophisticated versions of ray tracing as well, the repeated usage of said function is the dominant consumer of computer resources. This is a principal motivation for better or more efficient ray query algorithms. Note that the figure illustrates that the DE-tree is used dynamically in the sense that the scene data is expected to be different, be modified, or somehow change from image to image and therefore the DE-tree instance is created anew near the start of each iteration.

### BIBLIOGRAPHY

[Appel68] Apple, A., “Some techniques for shading machine renderings of solids”, Proc. Spring Joint Computer Conference (Atlantic City, Apr. 30-May 2, 1968), AFIPS Press, Arlington, Va., pp. 37- 45.
[Whitted84] Whitted, Turner, “An Improved Illumination Model for Shaded Display”, Communications of the ACM, vol. 23, No. 6, pp. 343-349 (un. 1980).
[Cook84] Cook, Robert L. et al., “Distributed Ray Tracing”, Computer Graphics, vol. 18, No. 3, pp.137-145, Jul., 1984.
[Cook91] Cook, Robert L. et al, “Pseudo-random point sampling techniques in computer graphics”, U.S. Pat. No. 5,025,400, Jun. 1991.
[Shir91] Shirley, P., “Radiosity via ray tracing.”, In Graphics Gems II, J. Arvo, Ed. Academic Press Professional, 1991.
[Wall94] Wallace, Johnn R. et all. “Three dimensional computer graphics employing ray tracing to compute form factors in radiosity.”, U.S. Pat. No. 5,313,568, May 1994.
[Prep85] F. Preparata and M. Shamos. Computational Geometry. Springer-Verlag, New York, 1985.
[Over88] M. H. Overmars, “Geometric data structures for computer graphics: an overview”, Theoretical Foundations of Computer Graphics and CAD, Edited by R. A. Earnshaw, Springer-Verlag, Berlin Heidelberg, 1988, pp.167-184.
[Arvo89] James Arvo and David Kirk, “A Survey of Ray Tracing Acceleration Techniques”, Chapter 6 in An Introduction to Ray Tracing, edited by Andrew S. Glassner, Academic Press, New York, 1989.
[DeBerg97] M. de Berg, M. van Kreveld, M. Overmars, O. Schwarzkopf, Computational Geometry-Algorithms and Applications. Springer-Verlag. 1997.
[Kay86] T. L. Kay and J. T. Kajiya Ray Tracing Complex Scenes, Computer Graphics (Proc. SIGGRAPH '86), 20(4), pp. 269-78, Aug. 1986.
[Szirm98] Szirmay-Kalos, L, Marton, G, “Worst-case versus average case” complexity of ray-shooting. Computing, 61(2):103-131,1998.
[Szirm02] L. Szirmay-Kalos, V. Havran, B. Balazs, L. Szecsi, “On the Efficiency of Ray-shooting Acceleration Schemes”, Proceedings of SCCG'02 conference, Budmerice, Slovakia, ACM SIGGRAPH, pp. 89-98, Apr. 2002.
[Havra99] Vlastimil Havran, “Analysis of Cache Sensitive Representations for Binary Space Partitioning Trees”, Informatica 23,3 (May 1999).
[Havra00A] Vlastimil Havran, “Heuristic Ray Shooting Algorithms”, Ph.D. Thesis, Faculty of Electrical Engineering, Czech Technical University, Prague. November 2000, (Available ONLINE).
[Havra00B] V. Havran and W. Purgathofer, “Comparison methodology for ray shooting algorithms”, Technical report TR-186-2-00-20 at Vienna University of Technology, Nov. 2000.
[Havra02A] V. Havran and J. Bittner, “On Improving KD-Trees for Ray Shooting”, Journal of WSCG, Volume 10, Number 1, pp. 209-217, February 2002. GOLEM homepage: www.cgg.cvut.cz/GOLEM
[Haines87] Eric A. Haines, “A proposal for standard graphics environments”, IEEE Computer Graphics and Applications, 7(11):3-5, Nov. 1987. (Available from www.acm.org/pubs/tog/resources/SPD)
[Wald01] Ingo Wald, Carsten Benthin, Markus Wagner and Philipp Slusallek, “Interactive Rendering with Coherent Ray Tracing”, Computer Graphics Forum (Proceedings of EUROGRAPHICS 2001), Alan Chalmers and Theresa-Marie Rhyne, editors. Blackwell Publishers, Oxford.
[Wald04] Ingo Wald, Andreas Diethrich and Philipp Slusallek, “An Interactive Out-ofCore Rendering Framework for Visualizing Massively Complex Models”, Eurographics Symposium on Rendering (2004), W. H. Jensen and A. Keller editors.
[Wald04B] Ingo Wald, “Realtime Ray Tracing and Interactive Global Illumination”. PhD thesis, Computer Graphics Group, Saarland University, 2004.
[Hook95A] David G Hook, “Algortihms For Accelerating Ray Tracing”, Thesis, Dept. of Engineering Computer Resources, University of Melbourne, May 1 995.
[Hook95B] David Hook and Kevin Forward, “Using Kd-trees to Guide Bounding Volume Hierarchies for Ray Tracing”, Australian ComputerJournal, Volume 27, Number 3, August 1995.
[Uhima91] Uhlmann, J. K., “Adaptive partitioning strategies for ternary tree structures”, Pattern Recognition Letters, volume 12, number 9, 1991.
[Macdo90] J. David MacDonald and Kellog S. Booth, “Heuristics for Ray Tracing Using Space Subdivision”, The Visual Computer, Vol 6, 1990, p.153-166.
[Gold87] J. Goldsmith and J. Salmon, “Automatic Creation of Object Hierarchies for Ray Tracing”, IEEE CG & A, 1987.
[Woo90] Woo, Andrew, “Fast Ray-Box Intersection”, in Graphics Gems, Andrew Glassner (editor), Academic Press, 1990.
[Shirley91] Shirley, Peter, “Radiosity via Ray Tracing”, in Graphics Gems II, James Arvo (editor), Academic Press, 1991.
[Sung 92] Sung, Kevin, and Shirley, Peter, “Ray Tracing with the BSP Tree”, in Graphics Gems II, David Kirk (editor), Academic Press, 1992.
[Agga98] Aggarwal et al. “System and method for construction of a data structure for indexing multidimensional objects.” U.S. Pat. No. 5,781,906, July 1998.
[Suda00] Sudarsky, Oded et al. “Method for displaying a graphic model”, U.S. Pat. No. 6,088,035, July 2000.
[Lath03] Lathrop, Olin . “Hierarchical space subdivision hardware for ray tracing”, U.S. Pat. No. 6,597,359, July 2003.
[Wrig99] Wrigley, Adrian . “Method of and apparatus for constructing an image of a notional scene by a process of ray tracing.”, U.S. Pat. No. 5,933,146, August 1999.
[Palm95] Palmer, I. J., and Grimsdale, R. L., “Collision detection for animation using sphere-trees.” Proc. Eurographics, 12(2), 1995.
[Gott96] Gottschalk, S. et al, “OBB-tree: A hierarchical structure for rapid interference detection.”, Computer Graphics, Proc SIGGRAPH'96, August 1996.
[Hubb95] Hubbard, P.Pm., “Collision detection for interactive graphics applications.”, IEEE Trans. On Visual and Comput. Graph., 1(3), Sept. 1995.

What is claimed is:

1. A method for creating data structures supporting ray, range, and related queries on a plurality of data records of entities, the method comprising: a partitioning step providing partitions of said data records into a plurality of subsets of said data records by isolating, into one of said subsets, the data records that represents either the entity of widest extent or that contribute to the bounding box of said plurality of data records.

2. The method of claim 1 further comprising the additional steps that perform partitioning by other means that are not the means of partitioning by .isolating, into one of the said subsets, the data records that represents the entity of widest extent.

3. The method of claim 2 where one of the additional steps comprises of partitioning by the object median.

4. The method of claim 2 where one of the additional steps comprises of partitioning by the spatial median.

5. The method of claim 2 where one of the additional steps comprises of partitioning by surface area heuristics.

6. The method of claim 1 where the created data structure is a binary search tree.

7. The method of claim 1 where the decision to isolate a given entity is based on the quality of the partitions by some pre-determined measure of quality.

8. The method of claim 1 where the decision to isolate a given entity is based on the relative extents of the widest object in comparison to the extent of plurality of data to partition.

9. The method of claim 6 where the decision to isolate a given object is based on the quality of the partitions by some measure of quality that considers the extents of current node, the left child node, the right child node.

10. The method of claim 6 where the decision to isolate a given object is based on the relative extents of the widest object in comparison to the extent of the current node that is being partitioned.

11. The method of claim 6 where the binary search tree is created in a top-down fashion.

12. The method of claim 6 where the binary search tree is created in a bottom-up fashion.

13. The method of claim 6 where said binary search tree comprises of nodes odes that are selected for partitioning on an as-needed basis by a search algorithm.

14. The method of claim 1 where the data records that represents the entity of widest extent are moved to another data structure.

15. The method of claim 6 where the data records that represents the entity of widest extent are moved to another data structure.

16. The method of claim 6 where said data records that represents the entity of widest extent, within the current node being partitioned, is moved to one of the child nodes of said current node being partitioned, and said child node is not assigned any further data records.

17. The method of claim 6 where a small subset of the data records associated with the node being partitioned are assigned to one of the child nodes of the current node, said small subset of data records containing the data record of the entity of widest extent, and all additional data records of said small subset being of entities that are nearly as wide as the entity of widest extent.

18. The method of claim 6 where the data records of the entity of widest extent that is associated with the node being partitioned, Is associated to a field of said node other then a child node of said node.

19. The method of claim 6 where the binary search tree is comprised of nodes, and said nodes comprising these fields:
B) splitDim which is the nodes partitioning dimension (this cab be maintained with two bits)
C) Four fields labeled min, max, lmax and rmin. For the splitDim coordinate of the DENode, min and max specify the range or the spatial extent of all objects associated with the node; min and lmax specify the range or the spatial extent of all objects associated with the nodes' left child; and rmin and max specify the range or the spatial extent of all objects associated with the nodes' right child
D) isLeaf ( a boolean ) indicating if the node is a leaf or an internal tree
E) isNull ( a boolean) to indicate if the node is null
F) Obj which is a reference or pointer to a graphics primitive
G) lnode and rnode which are pointers or references to the left child, and right child, respectively, of the node.

20. The method of claim 19, where one or more of the listed fields of said nodes are not explicitly contained but are implicitly or indirectly contained.

21. The method of claim 6 where the binary search tree is a kd-tree.

22. The method of claim 6 where the binary search tree is a BSP tree.

23. The method of claim 6 where the binary search tree is an octree or an octree of higher or lower dimensionality than three, such as a quadtree.

24. The method of claim 6 where the binary search tree is a bounding volume hierarchy.

25. The method of claim 19 where the search algorithm associated with the binary search tree is a range search algorithm.

26. The method of claim 19 where the search algorithm associated with the binary search tree is a ray query algorithm.

27. The method of claim 20 where the search algorithm associated with the binary search tree is a range search algorithm.

28. The method of claim 20 where the search algorithm associated with the binary search tree is a ray query algorithm.

29. The method of claim 28 where the search algorithm associated with the binary search tree is a ray query algorithm that performs these steps:
a) determine if the ray can intersect a tree node, said determination comprising of one of three dimensional components of a ray-box intersection test or ray-box rejection test
b) visit the child nodes whose extents are within the reach of the ray.

30. The method of claim 29 where the data structure is the DE- tree presented in the preferred embodiment.

31. An apparatus for creating data structures supporting ray, range, and related queries on a plurality of data records of entities, the apparatus comprising: a means for partitioning said data records into a plurality of subsets of said data records by isolating, into one of said subsets, the data records that represents the entity of widest extent or that contribute to the bounding box of said plurality of data records.

32. The apparatus of claim 31 further providing the means to perform partitioning by other means that are not the means of partitioning by .isolating, into one of the said subsets, the data records that represents the entity of widest extent.

33. The apparatus of claim 32 where one of the additional partitioning means comprises of partitioning by the object median.

34. The apparatus of claim 32 where one of the additional partitioning means comprises of partitioning by the spatial median.

35. The apparatus of claim 32 where one of the additional partitioning means comprises of partitioning by surface area heuristics.

36. The apparatus of claim 31 where the created data structure is a binary search tree.

37. The apparatus of claim 31 where said means makes a decision to isolate said data records that represents the entity of widest extent based on the quality of the partitions by some pre-determined measure of quality.

38. The apparatus of claim 31 where said means makes a decision to isolate said data records that represents the entity of widest extent based on the relative extents of the widest object in comparison to the extent of plurality of data to partition.

39. The apparatus of claim 36 where said means makes a decision to isolate said data records that represents the entity of widest extent based on the quality of the partitions by some measure of quality that considers the extents of current node, the left child node, and the right child node.

40. The apparatus of claim 36 where said means makes a decision to isolate said data records that represents the entity of widest extent based on the relative extents of the widest object in comparison to the extent of the current node that is being partitioned.

41. The apparatus of claim 36 where said binary search tree is created in a top-down fashion.

42. The apparatus of claim 36 where said binary search tree is created in a bottom-up fashion.

43. The apparatus of claim 36 where said binary search tree comprises of nodes that are selected for partitioning on an as-needed basis by a search algorithm.

44. The apparatus of claim 31 where the data records that represents the entity of widest extent are moved to another data structure.

45. The apparatus of claim 36 where said data records that represents the entity of widest extent are moved to another data structure.

46. The apparatus of claim 36 where said data records that represents the entity of widest extent, within the current node being partitioned, is moved to one of the child nodes of said current node being partitioned, and said child node is not assigned any further data records.

47. The apparatus of claim 36 where a small subset of the data records associated with anode being partitioned are assigned to one of the child nodes of the current node, said small subset of data records containing the data record of the entity of widest extent, and further containing additional data records of entities that are nearly as wide as the entity of widest extent.

48. The apparatus of claim 36 where said data records that represents the entity of widest extent associated with the node being partitioned, Is associated to a field of said node being partitioned, said field being a field other then a child node of said node being partitioned.

49. The apparatus of claim 36 where the binary search tree is comprised of nodes, and said nodes comprising these fields:
H) splitDim which is the nodes partitioning dimension (this cab be maintained with two bits)
I) Four fields labeled min, max, lmax and rmin. For the splitDim coordinate of the DENode, min and max specify the range or the spatial extent of all objects associated with the node; min and lmax specify the range or the spatial extent of all objects associated with the nodes' left child; and rmin and max specify the range or the spatial extent of all objects associated with the nodes' right child
J) isLeaf (a boolean) indicating if the node is a leaf or an internal tree
K) isNull (a boolean) to indicate if the node is null
L) Obj which is a reference or pointer to a graphics primitive
M) lnode and rnode which are pointers or references to the left child, and right child, respectively, of the node.

50. The apparatus of claim 49, where one or more of the listed fields of the said nodes are not explicitly contained but are implicitly or indirectly contained.

51. The apparatus of claim 36 where the binary search tree is a kd-tree.

52. The apparatus of claim 36 where the binary search tree is a BSP tree.

53. The apparatus of claim 36 where the binary search tree is an octree or an octree of higher or lower dimensionality than three, such as a quadtree.

54. The method of claim 6 where the binary search tree is a bounding volume hierarchy.

55. The apparatus of claim 36 where the search algorithm associated with the binary search tree is a range search algorithm.

56. The apparatus of claim 49 where the search algorithm associated with the binary search tree is a range search algorithm.

57. The apparatus of claim 49 where the search algorithm associated with the binary search tree is a ray query algorithm.

58. The apparatus of claim 50 where the search algorithm associated with the binary search tree is a range search algorithm.

59. The apparatus of claim 50 where the search algorithm associated with the binary search tree is a ray query algorithm.

60. The apparatus of claim 58 where the search algorithm associated with the binary search tree is a ray query algorithm that performs these steps:
a) determine if the ray can intersect a tree node, said determination comprising of one of three dimensional components of a ray-box intersection test or ray-box rejection test
b) visit the child nodes whose extents are within the reach of the ray.

61. The apparatus of claim 59 where the data structure is the DE-tree presented in the preferred embodiment.

62. The method of claim 1 where the search data structure is an m-way tree.

63. The apparatus of claim 31 where the created data structure is an m-way search tree.
